(19) United States
(12) Patent Application Publication
(10) Pub. No.: US 2015/0202958 A1
(43) Pub. Date: Jul. 23, 2015

(54) Apparatus for Securing Access to a Cap of a Tank

(71) Applicant: Groupe Mammut Inc., Montreal (CA)

(72) Inventor: Pierre-Luc Bouchard, Montreal (CA)

(21) Appl. No.: 14/603,346

(22) Filed: Jan. 22, 2015

Related U.S. Application Data
(63) Continuation-in-part of application No. PCT/CA2014/000049, filed on Jan. 23, 2014.

(30) Foreign Application Priority Data
Dec. 19, 2014 (CA) 2,875,885

(51) Int. Cl. B60K 15/04

(52) U.S. Cl. CPC B60K 15/0409

(57) ABSTRACT

Apparatus for securing access to an original cap of a tank comprising a surrounding element for fixedly engaging a filler neck below the cap and a secured cap for engaging the surrounding element over the cap (e.g., using equidistant screws). The secured cap comprises at least one opening allowing for locking the secured cap over the surrounding element. The secured cap may provide an inward flange with one or more flange slots for allowing at least one wing element of the surrounding element through the inward flange. The secured cap, in this example, engages the surrounding element by rotating the secured cap in relation to the surrounding element. The opening may allow for insertion of a lock for impeding the rotation of the secured cap over the surrounding element to avoid alignment of the flange slots with the wing elements. The tank may store fuel, lubricant or another liquid.

### PRIORITY STATEMENT

This non-provisional patent application claims priority based upon the prior PCT patent application entitled “APPARATUS FOR SECURING ACCESS TO A FUEL CAP OF A FUEL TANK”, application number PCT/CA2014/000049, filed Jan. 23, 2014, in the name of Groupe Mammut Inc., and Canadian Patent application entitled “APPARATUS FOR SECURING ACCESS TO A CAP OF A TANK”, application number 2,875,885, filed Dec. 19, 2014, in the name of Groupe Mammut Inc., all of which being hereby incorporated by reference.

### TECHNICAL FIELD

The present invention relates to securing access to a tank and, more particularly, to securing access to a cap of the tank.

### BACKGROUND

Different market conditions have created, in recent years, an increase in the number of fuel thefts. While this applies to various business segments, it is particularly noticeable for businesses that use heavy equipment where diesel tanks may hold 55 gallons or more. It has also been noticed that the current locking mechanism, especially on the heavy equipment, are ineffective at stopping the thieves. A similar problem has also been noticed for other types of fluid stored in tanks. In addition it has been noticed that the wrong type of liquid may sometimes be added to the wrong tank (e.g., fuel being added to a hydraulic oil tank or vice versa).

The present invention provides a solution that is meant to at least slow down a theft of liquid from a tank and/or protect access to the intake of the tank.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to an apparatus for securing access to an original cap of a tank. The apparatus comprises a surrounding element for fixedly engaging a filler neck of the tank below the cap and a secured cap for engaging the surrounding element over the cap, the secured cap comprising at least one opening allowing for locking the secured cap over the surrounding element.

The tank may be a fuel tank, a lubricant tank or another type of tank that stores a pumpable liquid.

The surrounding element may fixably engage the filler neck external periphery using at least one screw. There may be three equidistant screws for impeding longitudinal movement of the surrounding element along the filler neck external periphery. The at least one screw may further be made inaccessible once the secured cap engages the surrounding element.

The surrounding element may also comprise at least two ring sections around the filler neck.

In one exemplary embodiment, the secured cap provides an inward flange with one or more flange slots for allowing at least one wing element of the surrounding element through the inward flange. The secured cap, in this example, engages the surrounding element by rotating the secured cap in relation to the surrounding element. The number of flange slots may be equal or greater to the number of wing elements and the flange slots and the wing elements may be provided in a mutually cooperating pattern.

The at least one opening of the secured cap may allow for insertion of a lock for impeding the rotation of the secured cap over the surrounding element to avoid alignment of the one or more flange slots with the at least one wing element.

The at least one opening may be a slot through the secured cap and the lock may be a cylinder lock. In this example, once the cylinder lock is pushed, a lateral push pin of the cylinder lock engages a lateral aperture within the slot thereby maintaining the cylinder lock onto a receiving slot of the surrounding element. The receiving slot of the surrounding element may be positioned on the at least one wing element.

The at least one opening may be a slot through the secured cap and the lock may also be a padlock that, once locked, locks into a receiving slot through the surrounding element. At least one of the secured cap and the surrounding element may comprise a sleeve element for preventing the padlock from rotating when the padlock shackle is cut while the padlock is locked.

The secured cap may be engaging the surrounding element while allowing air circulation therebetween.

The surrounding element may be fixedly engaging the filler neck while allowing air circulation therebetween.

The apparatus may further comprise a cover for covering the at least one opening.

The secured cap may engage the surrounding element while allowing air circulation therebetween. Alternatively or complementarily, the surrounding element may be for fixedly engaging the filler neck while allowing air circulation therebetween.

The surrounding element and/or the secured cap may be provided in cast aluminum (e.g., 356), which may further be subjected to heat treatment (e.g., 356T6), which may be further machined to final dimensions and patterns.

The surrounding element and/or the secured cap may be provided in extruded aluminum (e.g., 6061) further machined to final dimensions and patterns.

### BRIEF DESCRIPTION OF THE DRAWINGS

Further features and exemplary advantages of the present invention will become apparent from the following detailed description, taken in conjunction with the appended drawings, in which:

FIG. 1A and FIG. 1B, herein referred to concurrently as FIG. 1, are exploded views of an exemplary filler neck assembly in accordance with the teachings of the present invention;

FIG. 2A and FIG. 2B, herein referred to concurrently as FIG. 2, are respectively an exploded perspective view and an assembled perspective view of an exemplary filler neck assembly and an exemplary apparatus in accordance with the teachings of the present invention;

FIG. 3A and FIG. 3B, herein referred to concurrently as FIG. 3, are respectively a perspective view and a plan view towards the inside of an exemplary secured cap in accordance with the teachings of the present invention;

FIG. 4A, FIG. 4B and FIG. 4C, herein referred to concurrently as FIG. 4, are respectively a perspective view and top views of exemplary surrounding elements in accordance with the teachings of the present invention;

FIG. 5A, FIG. 5B and FIG. 5C, herein referred to concurrently as FIG. 5, are respectively a perspective view and top views of exemplary surrounding elements in accordance with the teachings of the present invention;

FIG. 6 is a perspective view of an exemplary sleeve from an exemplary in accordance with the teachings of the present invention; and

FIG. 7 is a perspective view of an exemplary lock compatible with the teachings of the present invention.

### DETAILED DESCRIPTION

Embodiments of the present invention relate to an apparatus for securing access to an original cap of a tank. The original filler neck of the tank is fitted with a surrounding element (e.g., a ring formed by one or more sections). A secured cap is provided to fit over the original cap and to engage the surrounding element. The secured cap and the surrounding element further comprise cooperating structures to allow the secured cap to be locked over the surrounding element. General purpose locks of different types can be used for that purpose. Of course, locks specifically engineered for the present purpose could also be devised. The cap may be a fuel cap and the tank may be a fuel tank. Of course, skilled persons will readily understand that the present invention is also applicable to other pumpable liquids stored in tanks, such as different types of oil or lubricants (e.g., heavy-machinery hydraulic oil, used cooking oil, heating oil, etc.). The tank may be fixed to the ground permanently, disposed on the ground temporarily (e.g., brought on a site for the duration of a given project), on a vehicle (e.g., automobile, truck, heavy machinery, etc.) or on a transport platform (e.g., semi-trailer, trailer, tank truck, etc.). The tank may also be a pressurized tank or atmospheric tank. The cap may be gas tight, capable or not of withstanding internal pressure or may also be a semi-hermetic cap.

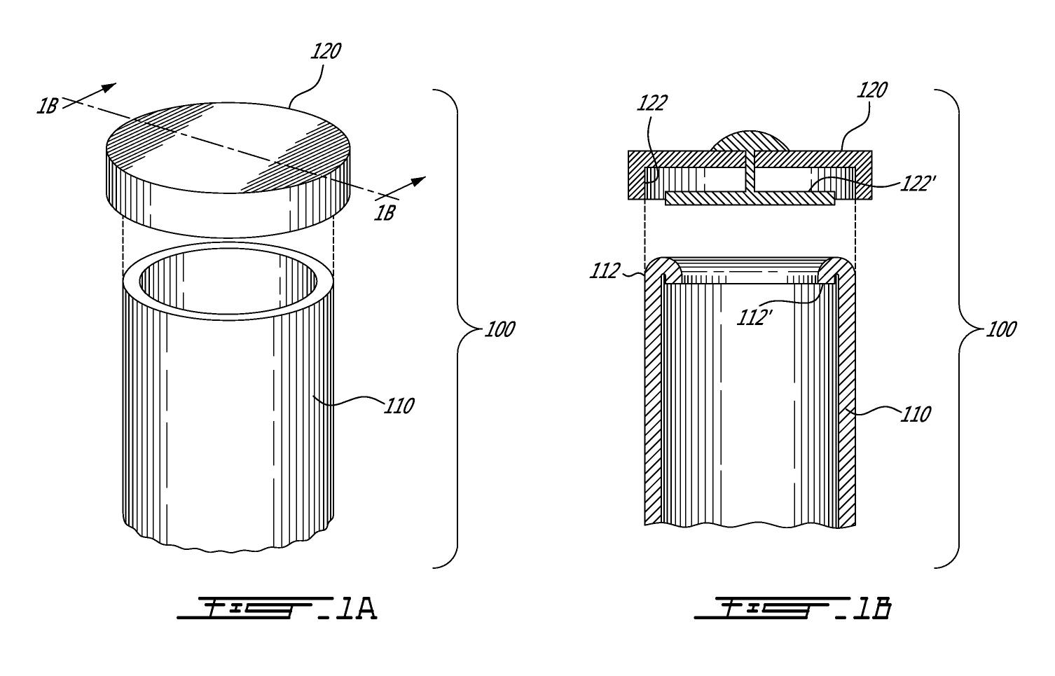

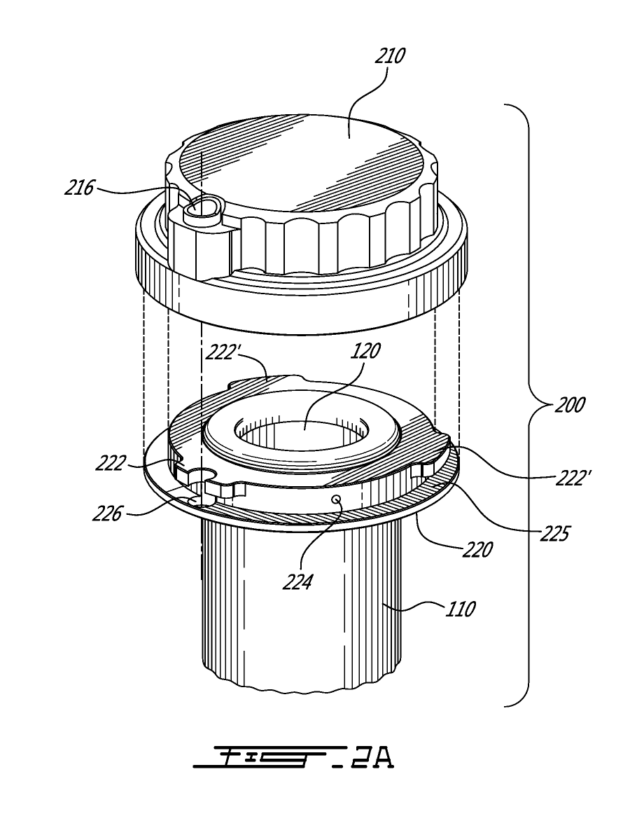

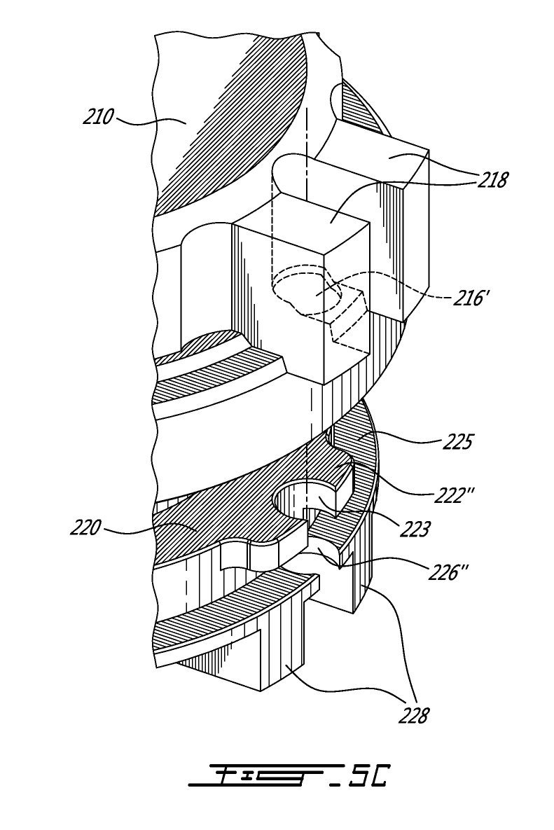

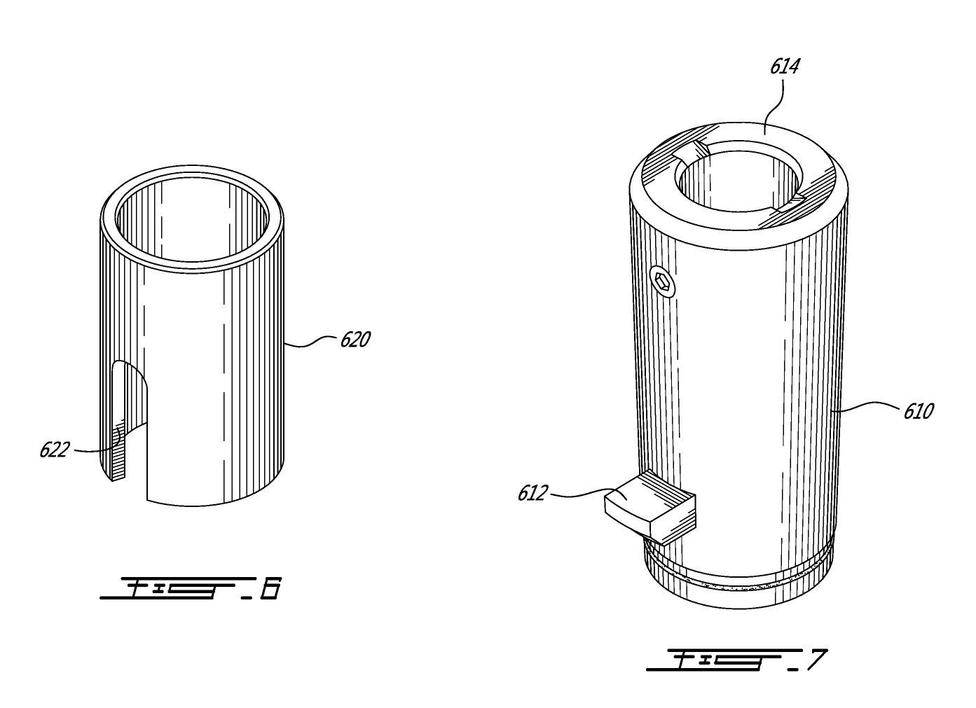

Reference is now made concurrently to FIGS. 1 to 7 of the accompanying drawings in which FIG. 1A shows a perspective view of a filler neck assembly 100 comprising a tank filler neck 110 and a cooperating fuel cap 120 in accordance with the teachings of the present invention. FIG. 1B shows a section view of the filler neck assembly 100, along the cut line A-A shown on FIG. 1A. FIGS. 1A and 1B are referred to together as FIG. 1. The filler neck 110 and the fuel cap 120 respectively provide securing means 112 and 122 to functionally maintain the fuel cap 120 and the filler neck 110 together in expected use of the fuel tank (not shown). For instance, the fuel tank may be provide on various types of heavy equipment (e.g., bulldozer, tractor, excavator) and the securing means 112 and 122 are meant for related use cases. Skilled person will readily understand that the present invention is not limited to the heavy equipment use cases, but may be readily adapted to various use cases of existing fuel cap and filler neck assemblies. A non-limiting list of exemplary securing means 112 and 122 include screw cap mechanism, snap mechanism, clip mechanism, twist and lock mechanism (e.g., 112′ and 122′), lift and turn, etc. A hinged cap (not shown) could also be used. The securing means 112 and 122 may or may not be air tight, which does not affect the teachings of the present invention.

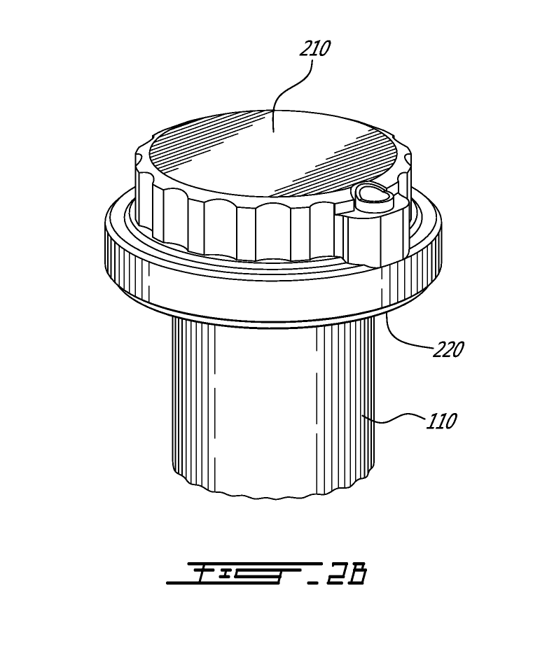

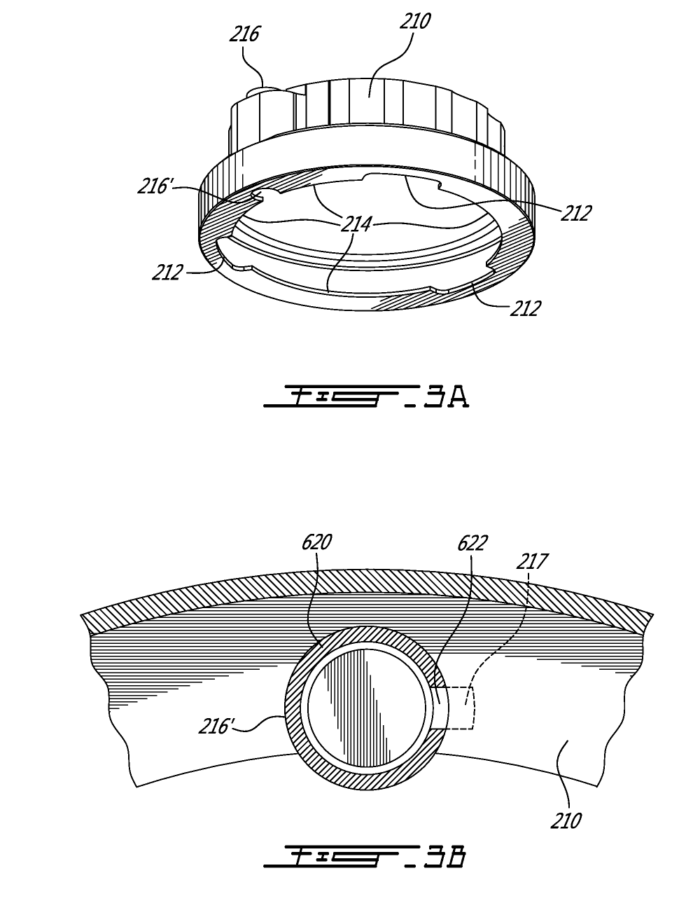

FIG. 2A and FIG. 2B, herein referred to concurrently as FIG. 2, show respectively an exploded perspective view and an assembled perspective view of the exemplary filler neck assembly 100 and an exemplary apparatus 200 for at least temporarily securing access to the fuel cap 120, in accordance with the teachings of the present invention. The apparatus 200 comprises a surrounding element 220 that engages the filler neck 110 below the fuel cap 120 and a secured cap that engages the surrounding element 220 over the fuel cap 120.

The surrounding element 220 may be maintained in position using different mechanisms. For instance, the surrounding element 220 may engage the filler neck 110 by providing one or more screw holes 224, which may receive or more screws such as hexagon socket headless set screws. Three equidistant holes 224 and a corresponding number of set screws appear to provide adequate stability and engagement force with the filler neck 110. Skilled persons will readily understand that more or less holes 224 and/or screws may be provided based on different context without departing from the teachings of the present invention. Furthermore, one or more of the holes 224 may be present in the surrounding element 220, but not used with a screw to engage the filler neck 110. The first purpose of the holes 224 and corresponding screws is for impeding longitudinal movement of the surrounding element along the external periphery of the filler neck 110. The holes 224 and corresponding screws, in usual circumstances, will also impede rotation of the surrounding element 220 around the external periphery of the filler neck 110. However, in the situation where the screws would fail to impede such rotation, the apparatus 200 would still succeed in at least temporarily securing access to the fuel cap 120 if the longitudinal movement is prevented.

In the example shown on FIG. 2, the surrounding element 220 is provided in one piece. Other exemplary surrounding elements are described with particular reference to

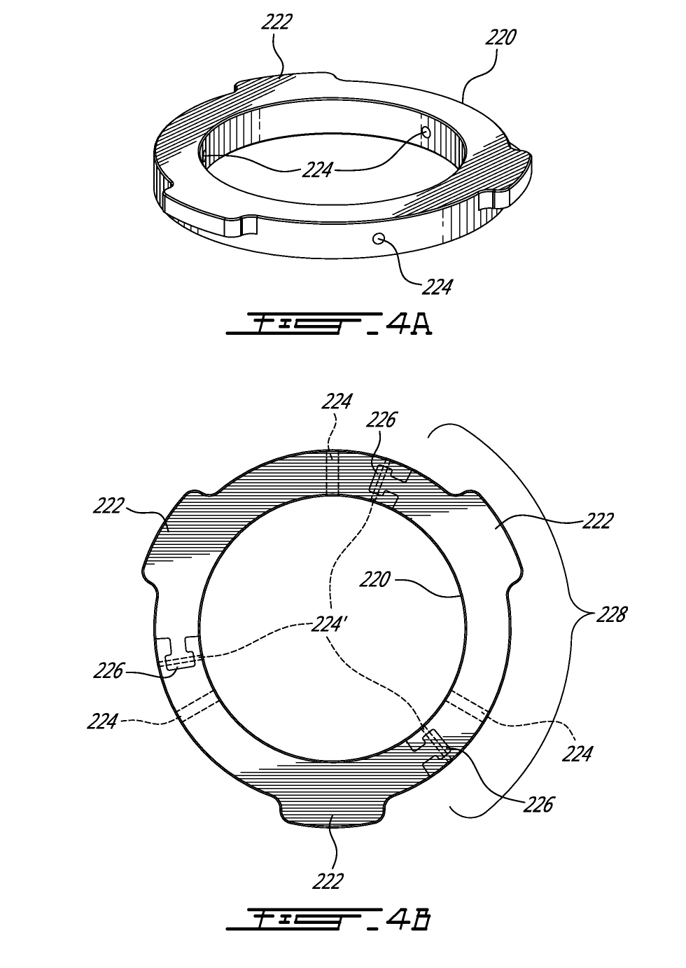

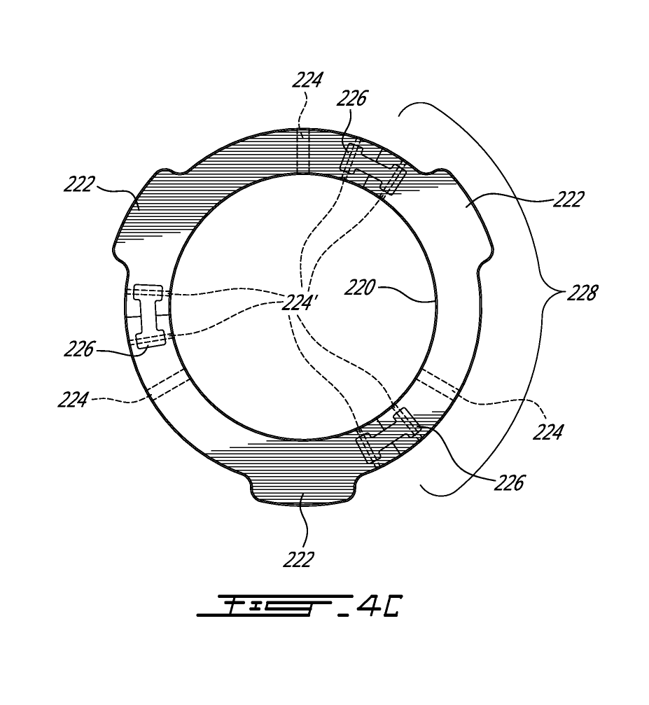

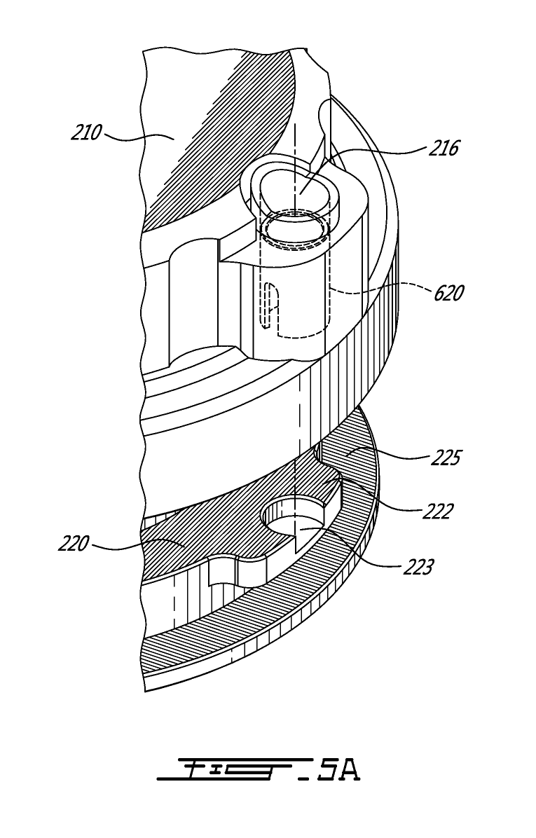

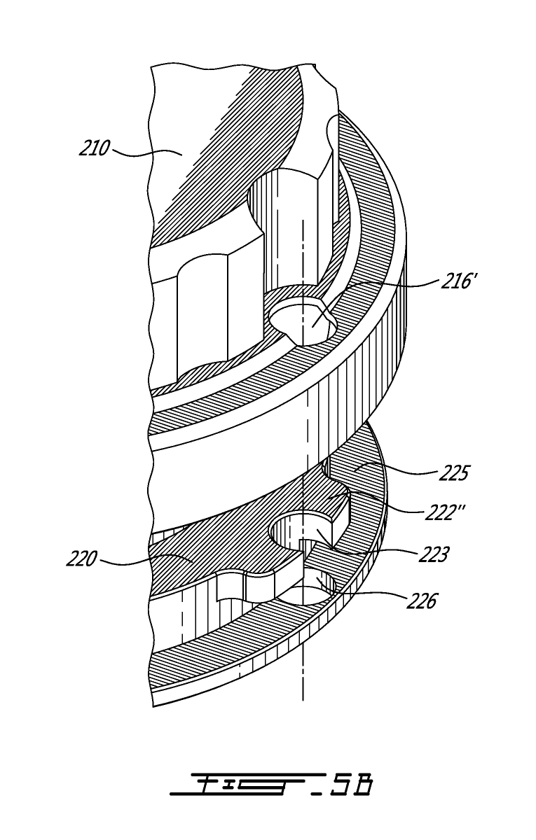

FIGS. 4 and 5. In the example shown on FIG. 2, the surrounding element 220 provides at least one wing element 222 for cooperating with the secured cap 210. In some embodiments, different wing elements 222 and 222′ may be provided. On FIG. 2, the wing element 222 is provided with an optional cutout section above an optional hole 226 of the surrounding element 220. Further details concerning the surrounding element 220, the wing element 222, the hole 226 and secured cap 210 will be provided with particular reference to FIGS. 3 to 7.

The secured cap 210 is arranged to fit the configuration of the surrounding element 220. For instance, the secured cap 210 may engage the surrounding element 220 by rotating thereover.

FIG. 3 shows a perspective view of the exemplary secured cap 210. The inside of the secured cap 210 is configured (e.g., cast, molded or machined) so as to leave enough room for the fuel cap 120 once the secured cap 210 engages the surrounding element 220. For instance, the inside of the secured cap 210 may accommodate original locks, clips or other protuberances present on the fuel cap 120 (not shown). The final dimensions of the original fuel cap 120 may, thus, be taken into consideration to provide specific dimensions of the secured cap 210.

In the example of FIG. 3, the secured cap 210 presents an inward flange 214 and one or more flange slots 212. The flange slots 212 allow the secured cap 210 to fit over the surrounding element 220. The flange 214 allows the secured cap 210 to engage the surrounding element 220 when the flange 214, by rotation, is misaligned with the wing elements 222 of the surrounding element 220. The number of flange slots 212 may be equal or greater to the number of wing elements 222. The flange slots 214 and the wing elements 222 may also be provided in a mutually cooperating pattern.

Skilled person will readily understand that the wing elements 222, the flange 214 and flange slots 212 present one example of an engagement mechanism in the apparatus 200 that allow the secured cap 210 and the surrounding element 220 to engage with one another. In the tests performed, the exemplified engagement mechanism showed results within expected parameters, at least in terms of sturdiness as well as in terms of ease of use. More specifically, the exemplified solution provides the exemplary advantage of being secured to sufficiently delay a conventional theft scenario and being rapid enough in removal and reinstallation for the conventional refueling methods. Other engagement mechanisms could be used (screw-in secured cap 210 over cooperating surrounding element 220, hinged (not shown) secured cap 210 connected to the surrounding element 220 on one side and clipped or otherwise maintained on an opposite side, etc.). It should be mentioned that the tests performed also showed that, while having an exposed hinged between the secured cap 210 and the surrounding element 220 may be sufficient in certain contexts or through certain dimensioning thereof, the hinge presented a single point of failure on the outside of the apparatus 200.

The screw holes 224 may be rendered inaccessible once the secured cap 210 engages the surrounding element 220, as exemplified on FIG. 2B. A lower flange 225 may be provided with relation to the external diameter of the secured cap 210. The secured cap 210 may stack with the lower flagger 225 or may also conceal the lower flange 225 therewithin (e.g., through a lip (not shown)).

In the example of FIG. 3, the secured cap 210 provides an opening (formed in the depicted example by a slot 216 aligned with a cutout section 216′ in the flange 214) is provided for insertion of a lock for impeding the rotation of the secured cap 210 over the surrounding element 220 to avoid alignment of the one or more flange slots 212 with the wing element(s) 222, as will be discussed further below.

The secured cap 210 and the surrounding element 220 may be provided in extruded aluminum (e.g., 6061) machined to final dimensions and patterns or other material suitable in different contexts. The 6061 aluminum has shown properties within expected ranges during testing of the apparatus 200. It is further expected that the surrounding element 220 and/or the secured cap 210 could be provided in cast aluminum (e.g., 356), which may further be subjected to heat treatment (e.g., 356T6), which may be further machined to final dimensions and patterns.

In one embodiment particularly exemplified on FIG. 5A, the lock is a cylinder lock 610 and the slot 216 and corresponding cutout 216′ allow the cylinder lock to be inserted from the inside of the secured cap 210. In one example, the slot 216 is shaped so as to prevent the cylinder lock from being extracted from the outside of the cap (e.g., smaller diameter than the cylinder diameter toward the outside portion of the slot 216). During use, once the cylinder lock 610 is pushed down towards the surrounding element 220, a lateral push pin 612 engages a lower lateral aperture 217 within the slot 216 thereby maintaining the cylinder lock 610 onto a receiving slot 223 of the surrounding element 220. The receiving slot 223 is shown on the surrounding element 220 positioned on one wing element 222. In this example, the hole 226 is not required. Other configurations involving the cylinder lock 610 or a cylinder lock of different dimensions may be provided. An optional cover (e.g., a spark plug cover) may also be provided for covering the slot 216 external opening (e.g., weather tight).

An optional sleeve 620 may also be inserted (e.g., press fit from the inside of the secured cap 210) to provide additional sturdiness. The sleeve 620 may be made of stainless steel. The exemplary sleeve 620 also provides a lateral opening 622 that aligns with the lateral aperture 217 and guides the lateral push pin 612. As skilled person will readily appreciate, the lateral push pin 612 allows the cylinder lock 620 to be pushed down without key while a key is required to operate the lateral push pin 622 and pull the cylinder lock 620 back up. An upper lateral aperture (not explicitly shown on FIG. 3B as it would be behind the lower aperture 217) could be provided to maintain the cylinder lock 620 in an unlocked position.

In other embodiments particularly exemplified on FIGS. 5B and 5C, the lock is a padlock (not shown). The opening or slot 216 and the cutout section 216′ extends through the secured cap 210 and the receiving slot is the hole 226 or hole section 226′ provided in the surrounding element 220 to receive the padlock. Once locked, the padlock locks through the receiving slot 226 or 226′ of the surrounding element 220. An optional sleeve element 218 and/or 228 for preventing the padlock from rotating when the padlock shackle is cut while the padlock is locked may further be provided. The sleeve element 218 or 228 may be used depending on the orientation of the padlock. Both sleeve elements 218 and 228 or only one may be provided.

The apparatus 200, through dimensioning of the secured cap 210 and/or the surrounding element 220, may further allow air circulation therebetween. This may be a requirement for the fuel cap 120 to operate correctly.

The surrounding element 220 may comprise at least two ring sections 228 around the filler neck 110. Different mating configurations 226 (e.g., with a lateral securing screw hole 224′) may be provided to ensure proper mechanical properties of the surrounding element 220. The lateral screw holes 224′ may be provided in addition to the one or more screw holes 224 or may also further replace the one or more screw holes 224. The screws through the holes 224′ may thus contribute to maintaining the sections 228 together and may also engage the filler neck 110.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. An apparatus for securing access to an original cap of a tank comprising:
a surrounding element for fixedly engaging a filler neck of the tank below the cap; and
a secured cap for engaging the surrounding element over the cap, the secured cap comprising at least one opening allowing for locking the secured cap over the surrounding element, wherein the secured cap provides an inward flange with one or more flange slots for allowing at least one wing element of the surrounding element through the inward flange, the secured cap engaging the surrounding element by rotating the secured cap in relation to the surrounding element.

2. The apparatus of claim 1, wherein the tank is a fuel tank, a lubricant tank or another type of tank that stores a liquid.

3. The apparatus of claim 1, wherein the surrounding element fixably engages the filler neck external periphery using at least one screw.

4. The apparatus of claim 3, further comprising three equidistant screws for impeding longitudinal movement of the surrounding element along the filler neck external periphery.

5. The apparatus of claim 3, wherein the at least one screw is inaccessible once the secured cap engages the surrounding element.

6. The apparatus of claim 1, wherein the surrounding element comprises at least two ring sections around the filler neck.

7. The apparatus of claim 1, wherein the number of flange slots is equal or greater to the number of wing elements.

8. The apparatus of claim 1, wherein the flange slots and the wing elements are provided in a mutually cooperating pattern.

9. The apparatus of claim 1, wherein the at least one opening allows for insertion of a lock for impeding the rotation of the secured cap over the surrounding element to avoid alignment of the one or more flange slots with the at least one wing element.

10. The apparatus of claim 9, wherein the at least one opening is a slot through the secured cap and the lock is a cylinder lock, the slot allowing the lock to be inserted from the inside of the secured cap and preventing the lock from being extracted from the outside of the cap, wherein, once the lock is pushed, a lateral push pin of the cylinder lock engages a lateral aperture within the slot thereby maintaining the cylinder lock onto a receiving slot of the surrounding element.

11. The apparatus of claim 10, wherein the receiving slot of the surrounding element is positioned on the at least one wing element.

12. The apparatus of claim 9, wherein the at least one opening is a slot through the secured cap and the lock is a padlock that, once locked, locks into a receiving slot through the surrounding element.

13. The apparatus of claim 12, wherein at least one of the secured cap and the surrounding element comprise a sleeve element for preventing the padlock from rotating when the padlock shackle is cut while the padlock is locked.

14. The apparatus of claim 1, further comprising a cover for covering the at least one opening.

15. The apparatus of claim 1, wherein the secured cap is for engaging the surrounding element while allowing air circulation therebetween.

16. The apparatus of claim 1, wherein the surrounding element is for fixedly engaging the filler neck while allowing air circulation therebetween.

17. The apparatus of claim 1, wherein the surrounding element and/or the secured cap are provided in cast aluminum.

18. The apparatus of claim 17, wherein the surrounding element and/or the secured cap are further machined to final dimensions and patterns.

19. The apparatus of claim 1, wherein the surrounding element and/or the secured cap are provided in extruded aluminum further machined to final dimensions and patterns.
